(19) United States
(12) Patent Application Publication
(10) Pub. No.: US 2019/0144063 A1
(43) Pub. Date: May 16, 2019

(54) INTEGRATED FRONT OR REAR RACK CONNECTION ASSEMBLY FOR A BICYCLE

(71) Applicant: Matthijs van Leeuwen, Burien, WA (US)

(72) Inventor: Matthijs van Leeuwen, Burien, WA (US)

(21) Appl. No.: 15/814,603

(22) Filed: Nov. 16, 2017

(51) Int. Cl. B62J 9/00; B62J 11/00; B62J 7/04; B62J 7/08

(52) U.S. Cl. CPC B62J 9/005; B62J 11/00; A45F 3/04; B62J 7/08; B62J 7/04

(57) ABSTRACT

An integrated rack connection assembly detachably attached to the front or rear portion of the bicycle. The integrated rack connection assembly includes tube clamp assembly, platform, a bracket, side frame extension and top frame extension. The tube clamp assembly includes a plurality of tubes integrated with a plate for an attachment at the front portion of down tube or with the rear portion of a seat tube. The down tube or seat tube is clamped with tube clamp assembly by utilizing screws. The platform to carry basket or bags is placed between the plurality of tubes of the tube clamp assembly in a horizontal position by flipping it when used in front or rear of the bicycle. The seat tube and the down tube of a bicycle are positioned in opposite angle. While attached, the seat or down tube extends into a rack to distribute weights of baskets or bags.

### TECHNICAL FIELD

The present disclosure relates to the field of a bicycle rack, and more particularly the present invention relates to an integrated rack connection assembly detachably attached to the front or the rear portion of a bicycle to carry baskets and bags.

### BACKGROUND

A bicycle rack is a great convenience to carry goods on a bicycle. Generally, a rack for a bicycle is known for having a baggage bearing surface. However, the existing racks and mechanisms to carry the bags or the baskets are often insufficient and fail to carry large bags or baskets. Further, these racks do not provide driving stability to the user while carrying the luggage. In addition to that, a lot of electric bicycles use the rear rack to carry the battery and as such inactivates it for carrying goods. Additionally, the existing racks are generally not designed to carry heavy loads. Furthermore, most of the bicycles do not come with the front carriers and adding a front carrier is difficult given the lack of generically attachable front carriers.

Therefore there is a dire need of an integrated rack connection assembly which is detachably attached to a frame of the bicycle so that a user may carry a heavy baggage on the rack without any intrusion. Further, there is also a need for an integrated rack connection assembly detachably for a bicycle which provides the user with a stable drive while carrying the large load of baggage. Additionally, an integrated rack is optimally fitted when it can either fit in front or in the rear of a bicycle.

Thus, in view of the above, there is a long-felt need in the industry to address the aforementioned deficiencies and inadequacies.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

The present invention mainly solves the technical problems of the prior art existed. In response to these problems, the present invention provides an integrated rack connection assembly detachably attached to a frame of a bicycle, as shown in and/or described in connection with at least one of the figures, as set forth more completely in the claims.

The present integrated rack connection assembly detachably attached to the front or the rear portion of a bicycle. The integrated rack connection assembly includes a tube clamp assembly, a platform, a bracket, a side frame extension, and a top frame extension. The tube clamp assembly includes a plurality of tubes. The plurality of tubes is integrated with a clamp plate for an attachment at the front portion of a down tube or with the rear portion of a seat tube of the bicycle. The down tube or the seat tube is clamped with tube clamp assembly by utilizing four screws. A horizontally aligned platform is attached to the clamped part of the rack by utilizing at least four screws. Two screws are used for each side of the platform portion.

The platform can be horizontally aligned and attached to carry a basket or bag by flipping the horizontal position when attached by placing the platform in between the plurality of tubes of the tube clamp assembly which is either attached to the seat tube or the down tube of the bicycle. The seat tube and the down tube are positioned in opposite angle. While attached, the seat tube or the down tube extends into a rack to distribute weights of baskets or bags.

In an aspect, the integrated rack connection assembly fits either on the front portion to the down tube or rear portion to the seat tube of the bicycle and the platform is horizontally aligned by flipping as the platform is attached to the tube clamp assembly.

In an aspect, the bracket is designed to enable the rack to carry basket. The bracket is clamped on a bottom surface of the basket to secure the basket on top of the horizontal rack portion.

In an aspect, the side frame extension is configured on each side of the platform to secure bags. The side frame extensions are of a rectangular shape with four corners welded together by tubes.

In an aspect, the top frame extension is configured to secure a bag on top of the platform and can be alternatively utilized in place of the bracket when a bag is carried instead of a basket.

In an aspect, the bracket may hold any type of basket by drilling holes in the bottom surface of the basket, or in the case of a wired basket, clamping the bottom surface of the basket with the bottom support of the bracket.

In an aspect, the first wheel block, the second wheel block, and the metal strip are placed in a position to secure the bag. In an aspect, the first wheel block, the second wheel block, and the metal strip are placed in a locked position when an angle of 4 degrees creates between the two splits of metal strips.

The present integrated rack connection assembly is installed as a bicycle main frame extension which creates a universal way of carrying more load on the bicycle than the regular bicycle racks can carry. Further, the present integrated rack connection assembly connects to an integral part of the bicycle which i.e. the seat tube or the down tube. The intersection of the seat tube and the down tube are generally the location for the chainset and pedals. The weight on the bicycle gets distributed through these frame components so that the present integrated rack connection assembly can carry more loads.

Furthermore, the present integrated rack connection assembly provides side and/or top frame extensions to hold bags. The side or top frame extensions are designed in such a way that it cannot only carry bags with the present integrated rack connection assembly but also carries the other bicycle bags with traditional connection systems as well. The top frame extension allows bags to be easily attached on top of the rack instead of on the side, which is beneficial when bags are heavy. The bag connection mechanism as described before consisting of two-wheel blocks are less intrusive when carrying the bag than traditional bag connection methods.

In an aspect, the bag connection mechanism with the first wheel block, the second wheel block, and the metal strip are attached to a bag placed in a vertical position by pushing down the metal strip into lock position so both wheels at the end of the strip are locked into the side or top frame extension.

In order to attach a bag to the side or top frame extension, the bag needs to be equipped with a bag connection mechanism that includes a first wheel block, a second wheel block, and a metal strip. The metal strip splits from the center into two joint pieces, and operable to place the first wheel block, and the second wheel block in the widest position. The bag is securely locked in the bracket when the first wheel block and the second wheel block are placed in the widest position. Further, the bag is removed from the bracket by pulling the center of the metal strip, which shortens the position, and then releases the bag from the bracket.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. Any person with ordinary skill in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates an isometric view of the integrated front or rear rack connection assembly, in accordance with at least one embodiment;

FIG. 2 illustrates a side view of the integrated front or rear rack connection assembly detachably attached to a frame of a bicycle on the front and rear side, in accordance with at least one embodiment;

FIG. 3 illustrates an isometric view from the bottom of the integrated front or rear rack connection assembly with an installed basket bracket, in accordance with at least one embodiment;

FIG. 4 illustrates a perspective view of the bicycle with the bracket and a wire box, in accordance with at least one embodiment;

FIG. 5 illustrates side bag-bracket connection in closed condition, in accordance with at least one embodiment;

FIG. 6 illustrates side bag-bracket connection in open condition, in accordance with at least one embodiment;

FIG. 7 illustrates an isometric view of a bicycle with bags installed on the bag-brackets installed on the integrated front or rear rack connection assembly both front and rear, in accordance with at least one embodiment;

FIG. 8 illustrates top bag-bracket connection with bag installed, in accordance with at least one embodiment; and

FIG. 9 illustrates the load distribution on the bicycle with the integrated front or rear rack connection assembly detachably attached to a frame of a bicycle on the front and rear side, in accordance with at least one embodiment.

### DETAILED DESCRIPTION

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily include that particular feature, structure, characteristic, property, element, or limitation. Further, repeated use of the phrase “in an embodiment” does not necessarily refer to the same embodiment.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques, and procedures either known to, or readily developed from known manners, means, techniques and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

In operation, the present integrated rack connection assembly detachably attached to either front portion or rear portion of the bicycle. The integrated rack connection assembly includes a tube clamp assembly, a platform, a bracket, a side frame extension, and a top frame extension. The tube clamp assembly includes a plurality of tubes. The plurality of tubes is integrated with a clamp plate for an attachment at the front portion of a down tube or with the rear portion of a seat tube of the bicycle. The down tube or the seat tube is clamped with tube clamp assembly by utilizing four screws.

The platform can be horizontally aligned and attached to carry a basket or bag by flipping the horizontal position when attached by placing the platform in between the plurality of tubes of the tube clamp assembly which is either attached to the seat tube or the down tube of the bicycle. The seat tube and the down tube are positioned in opposite angle. While attached, the seat tube or the down tube extends into a rack to distribute weights of baskets or bags.

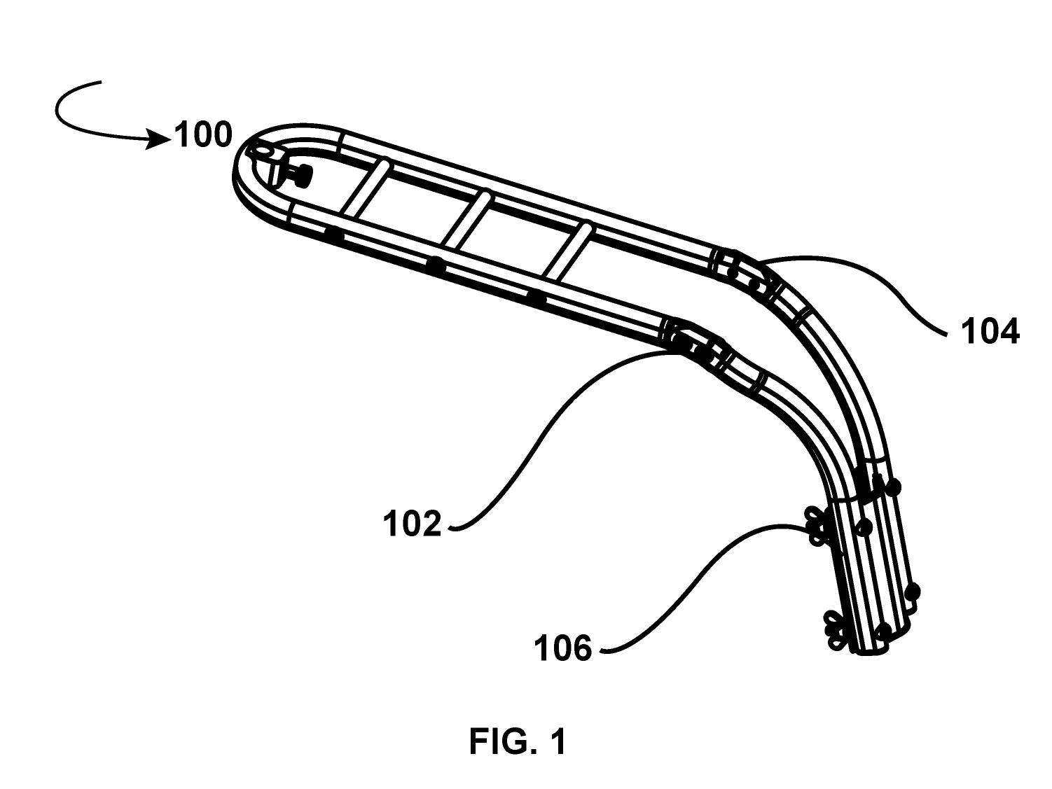

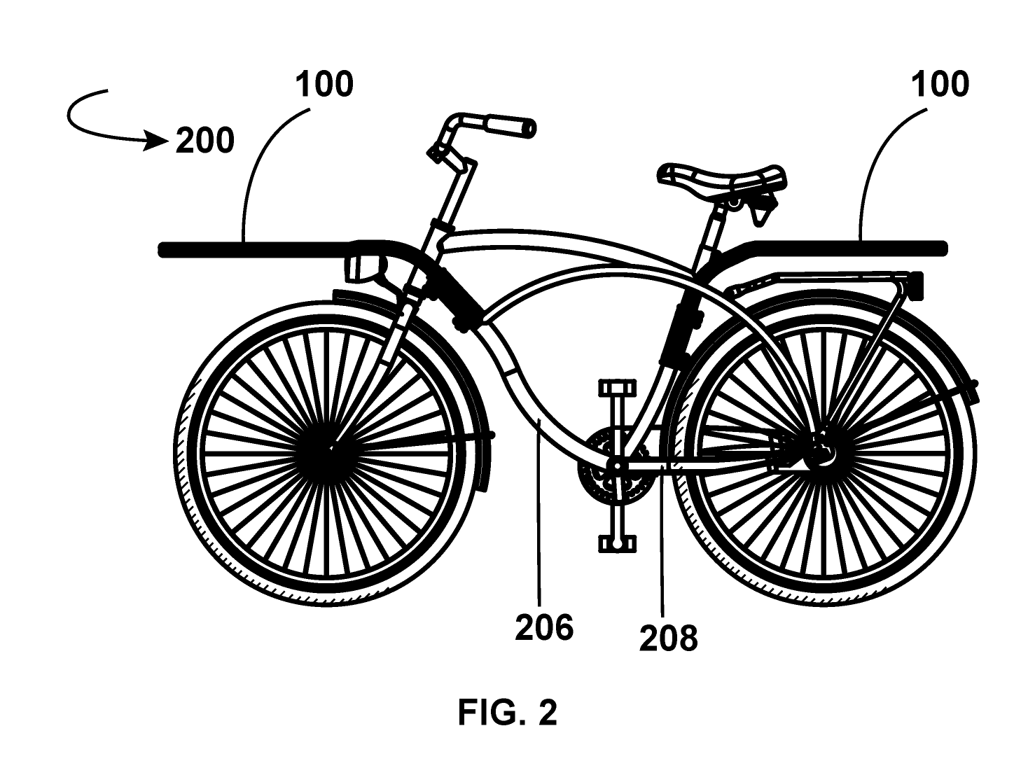

FIG. 1 illustrates an isometric view of the integrated front or rear rack connection assembly 100, in accordance with at least one embodiment. The integrated front or rear rack connection assembly 100 includes a horizontal platform with two connection pieces 102 and 104. Each of the connection piece 102 and 104 coupled to the down tubes or the seat tubes to allow the integrated rack assembly to be apart in two pieces and the horizontal platform to be flipped for use on the front and rear side of the bicycle. Further, the integrated front or rear rack connection assembly 100 includes a tube clamp assembly 106 (explained in conjunction with FIG. 2).

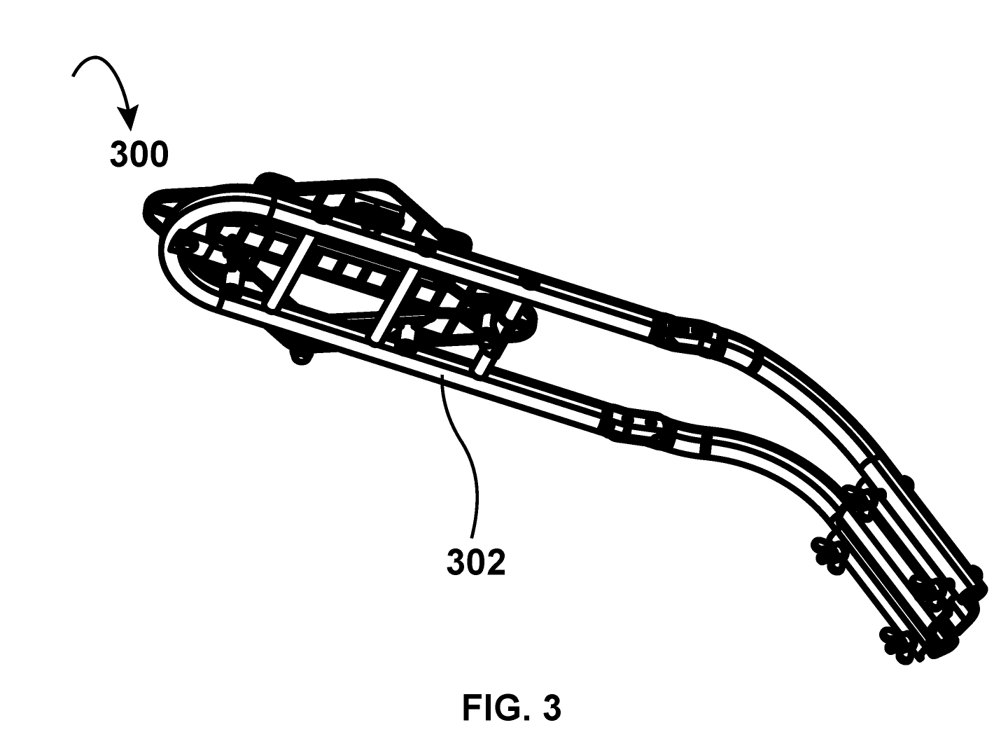

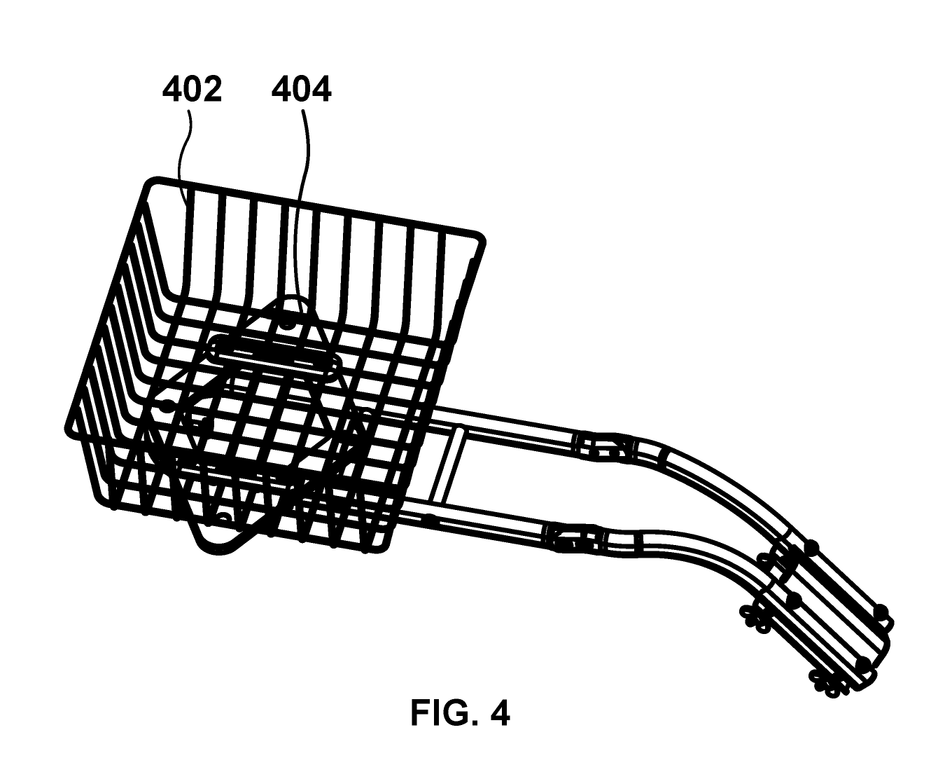

FIG. 2 illustrates a side view of the integrated front or rear rack connection assembly 100 detachably attached to a frame of a bicycle 200 on the front and rear side, in accordance with at least one embodiment. FIG. 2 is explained in conjunction with FIG. 1. The integrated rack connection assembly 100 includes a tube clamp assembly 106 (shown in FIG. 1), and a bracket, a side frame extension, and a top frame extension (shown in FIG. 3 and FIG. 4). The tube clamp assembly 106 includes a plurality of tubes. The plurality of tubes is integrated with a clamp plate for an attachment at the front portion of a down tube 206 or with the rear portion of the seat tube 208 of the bicycle 200. The down tube 206 or the seat tube 208 is clamped with tube clamp assembly 106 by utilizing four screws.

FIG. 3 illustrates an isometric view 300 from the bottom of the integrated front or rear rack connection assembly with the installed bracket, in accordance with at least one embodiment. FIG. 3 is explained in conjunction with FIG. 2. A horizontally aligned platform is attached to the clamped part of the rack by utilizing at least four screws. Two screws are used for each side of the platform portion. The platform 302 is horizontally aligned and attached to carry a basket or bag by flipping the horizontal position when attached by placing the platform in between the plurality of tubes of the tube clamp assembly which is either attached to the seat tube 208 (shown in FIG. 2) or the down tube 206 (shown in FIG. 2) of bicycle 200 (shown in FIG. 2). The seat tube 208 (shown in FIG. 2) and the down tube 206 (shown in FIG. 2) are positioned in opposite angle. While attached, the seat tube 208 (shown in FIG. 2) or the down tube 206 (shown in FIG. 2) extends into a rack to distribute weights of baskets or bags.

FIG. 4 illustrates a perspective view 400 of the bicycle 200 (shown in FIG. 2) with the bracket 404 and a wire box 402, in accordance with at least one embodiment. FIG. 4 is explained in conjunction with FIGS. 1 and 2. The integrated rack connection assembly 100 (shown in FIG. 1) fits either on the front portion to the down tube or rear portion to the seat tube of the bicycle. The platform is horizontally aligned by flipping as the platform is attached to the tube clamp assembly.

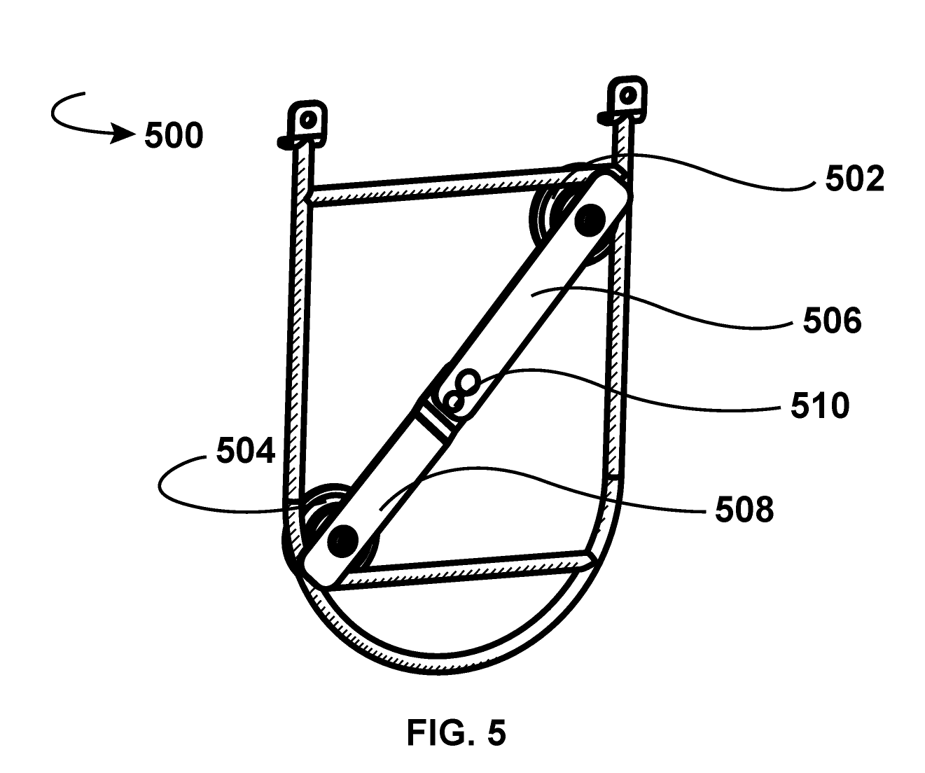

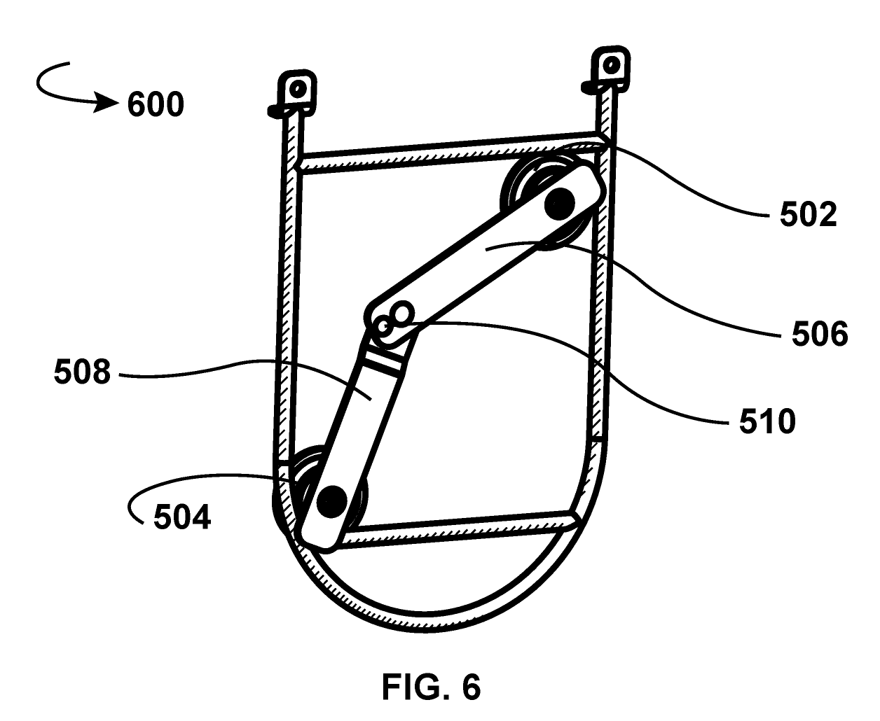

FIG. 5 illustrates side bag-bracket connection in closed condition 500, in accordance with at least one embodiment. The side frame extensions are of a rectangular shape with four corners welded together by tubes. FIG. 6 illustrates side bag-bracket connection in open condition 600, in accordance with at least one embodiment. The top frame extension is configured to secure the bag on top of the platform and can be alternatively utilized in place of the first bracket when a bag is carried instead of a basket.

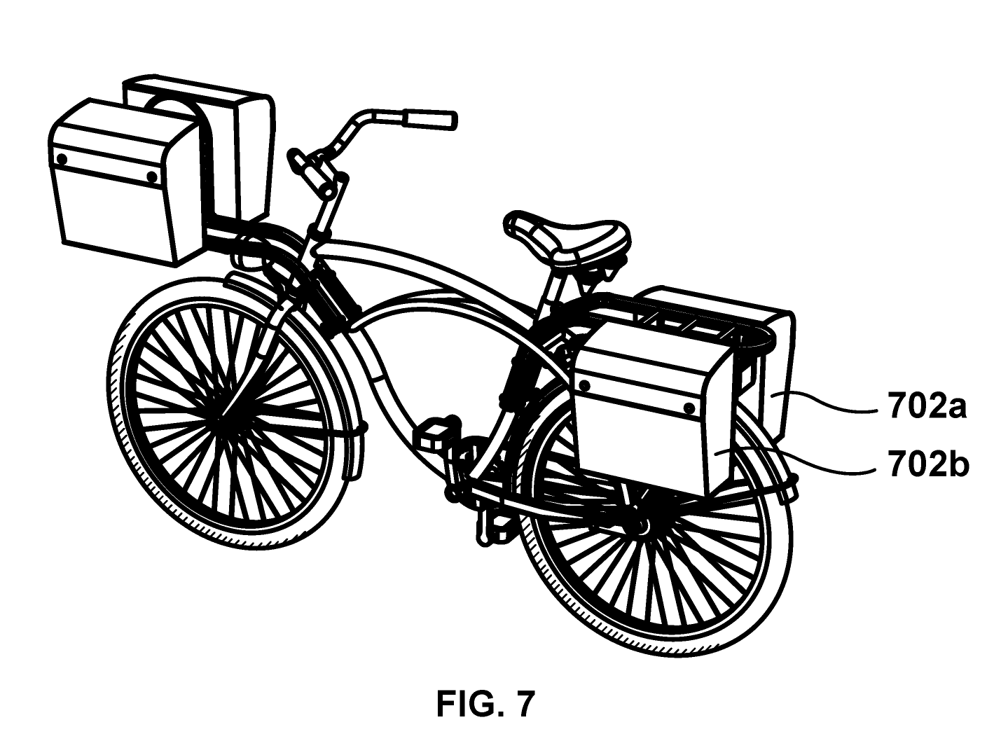

FIG. 7 illustrates an isometric view of a bicycle with bags installed on the bag-brackets installed on the integrated front or rear rack connection assembly both front and rear, in accordance with at least one embodiment. The integrated rack connection assembly 100 includes a bracket, a side frame extension, and a top frame extension. The bracket enables the rack to carry baskets. The bracket is clamped on a bottom surface of the basket to secure the basket on top of the horizontal rack portion. In an embodiment, the side frame extension is configured on each side of the platform to secure bags 702a and 702b.

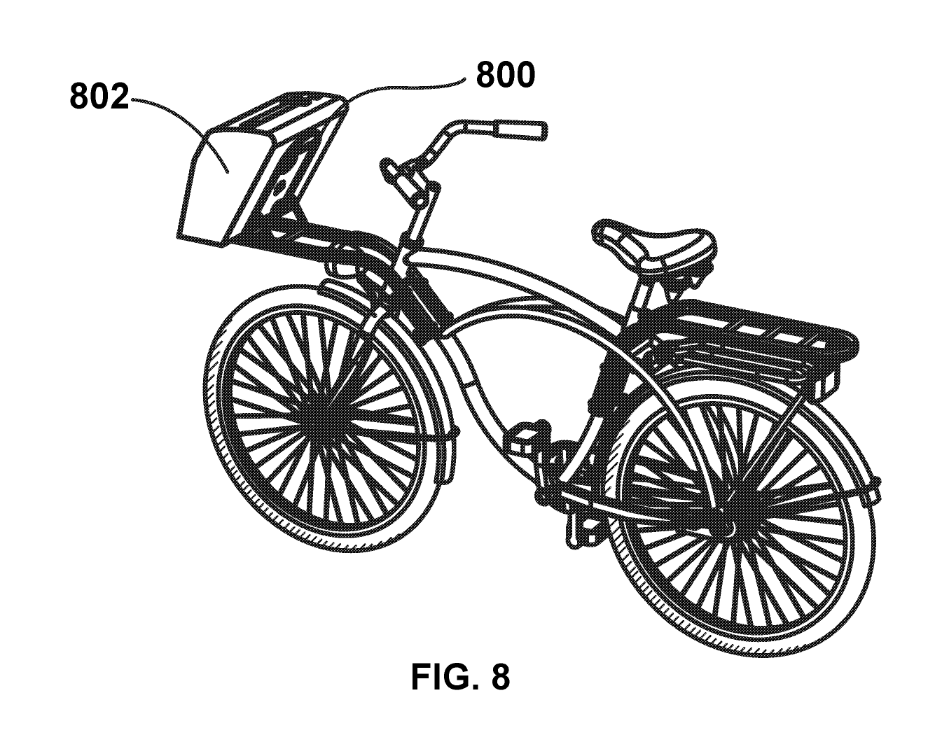

FIG. 8 illustrates top bag-bracket connection 800 with a bag 802 installed, in accordance with at least one embodiment. The top bracket-basket connection allows baskets or bags to be easily attached on top of the rack instead of on the side, which is beneficial when bags are heavy. The bag is equipped with a bag connection mechanism which enables the bag to be attached to the side or top frame extension. The bag connection mechanism includes a first wheel block 502, a second wheel block 504, and a metal strip (splits as 506, and 508).

The metal strip splits from the center into two joint pieces as 506, and 508, and operable to place the first wheel block 502, and the second wheel block 504 in the widest position. The bag is securely locked in the bracket when the first wheel block 502 and the second wheel block 504 are placed in the widest position. Further, the bag is removed from the bracket by pulling the center of the metal strip 506 and 508, which shortens the position, and then releases the bag from the bracket.

The first bracket may hold any type of basket by drilling holes in the bottom surface of the basket, or in the case of a wired basket, clamping the bottom surface of the basket with the bottom support of the bracket. In an embodiment, the bag connection mechanism with the first wheel block 502, the second wheel block 504, and the metal strip 506 and 508 are attached to a bag placed in a vertical position by pushing down the metal strip into lock position so both wheels at the end of the strip are locked into the side or top frame extension. In an embodiment, the first wheel block 502, the second wheel block 504, and the metal strip 506 and 508 are placed in a position to secure the bag.

The present integrated rack connection assembly 100 is installed as a bicycle main frame extension which creates a universal way of carrying more load on the bicycle than the regular bicycle racks can carry. In an embodiment, the first wheel block 502, the second wheel block 504, and the metal strip 506 and 508 are placed in a locked position when an angle of 4 degrees creates between the two splits of metal strips. The weight on the bicycle gets distributed through these frame components so that the present integrated rack connection assembly can carry more loads. The side or frame extension is designed in such a way that it cannot only carry the present integrated rack connection assembly but also carries the other bicycle bags with traditional connection systems as well.

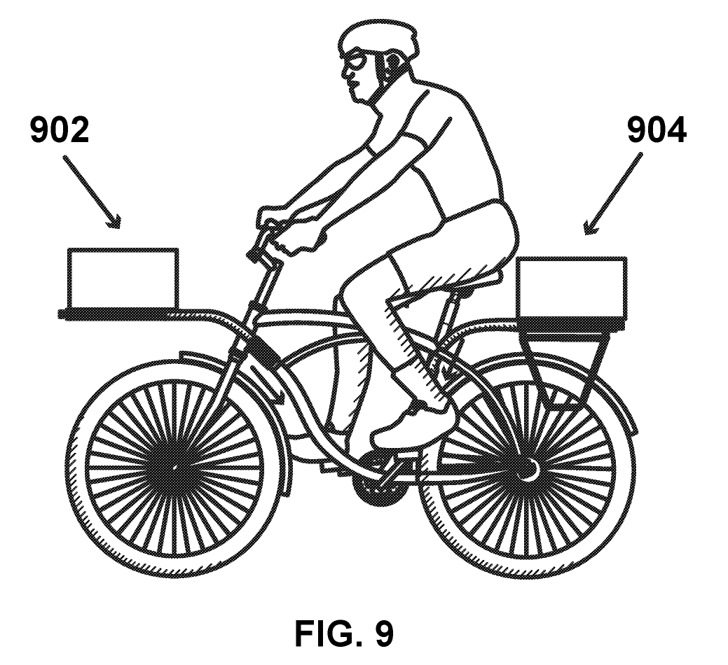

FIG. 9 illustrates the load distribution on the bicycle with the integrated front or rear rack connection assembly detachably attached to a frame of a bicycle on the front and rear side, in accordance with at least one embodiment. The rear portion 904 and the front portion 902 of the corresponding rack are attached to the vital parts of the frame of the bicycle so that the present integrated rack connection assembly 100 can carry heavier loads and distribute the weights of the loads through the weight center of the bicycle 200 (i.e. crank between the two wheels).

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention covers the modifications and variations of this invention, provided they are within the scope of the appended claims and their equivalents.

1. An integrated rack connection assembly detachably attached to the front or the rear portion of a bicycle, the integrated rack connection assembly comprising:
a tube clamp assembly having a plurality of tubes integrated with a plate for an attachment with the front portion at the down tube or with the rear portion at the seat tube of the bicycle, wherein the down tube or the seat tube is clamped with the tube assembly by using four screws and a clamp plate, further a horizontally aligned platform is attached to the tube clamp assembly by utilizing at least four screws;
a platform is horizontally aligned and attached to carry a basket or a bag by flipping horizontal position when attached by placing the platform in between the plurality of tubes of the tube clamp assembly which is either attached to the seat tube or the down tube of the bicycle, wherein the seat tube and the down tube are positioned in opposite angle, further the seat tube or the down tube extends into a rack to distribute weights of the baskets or bags.

2. The integrated rack connection assembly according to claim 1 comprises a bracket wherein the bracket clamped on a bottom surface of the basket to secure the basket on top of the horizontal rack portion.

3. The integrated rack assembly according to claim 2 wherein the bracket may hold any type of basket by drilling holes in the bottom surface of the basket, or in a case of a wired basket, clamping the bottom surface of the basket with the bottom support of the bracket.

4. The integrated rack connection assembly according to claim 1 comprises a side frame extension wherein the side frame extension is configured on each side of the platform to secure the bags.

5. The integrated rack connection assembly according to claim 1 comprises a top frame extension wherein the top frame extension is configured to secure the bag on top of the platform.

6. The integrated rack connection assembly according to claim 1 further includes a bag connection mechanism, wherein the bracket connection mechanism comprising:
a first wheel block; a second wheel block; and
a metal strip splits from center into two joint pieces, and operable to place the first wheel block, and the second wheel block in a widest position, wherein the bag is securely locked in the bracket when the first wheel block and the second wheel block are placed in the widest position, further the bag is removed from the bracket by pulling center of the metal strip, which shortens the position, and then releases the bag from the bracket.

7. The bag connection mechanism according to claim 6 wherein the first wheel block, the second wheel block, and the metal strip are attached to a bag.

8. The bag connection mechanism according to claim 6 wherein the first wheel block, the second wheel block, and the metal strip are placed in a position to secure the bag by pushing down the metal strip into a lock position.

9. The bag connection mechanism according to claim 6 wherein the first wheel block, the second wheel block, and the metal strip are placed in a locked position when frame tubes of the side or top frame extension are in between the edges of the wheels and the bag.

10. The integrated rack connection assembly according to claim 1, wherein the tube clamp assembly is clamped around the down tube or the seat tube to distribute the weight down to center of the bicycle, and the horizontal rack portion is installed to be utilized either at the front portion of the bicycle or the rear portion of the bicycle.
